(19) United States
(12) Patent Application Publication
(10) Pub. No.: US 2026/0029917 A1
(43) Pub. Date: Jan. 29, 2026

(54) READ OPERATIONS FOR COMPUTATIONAL MODELS

(71) Applicant: Micron Technology, Inc., Boise, ID (US)

(72) Inventors: Yanhua Bi, Shanghai (CN); John R. Herwig, Boise, ID (US); Luigi Costanzo, Trentola Ducenta (CE) (IT); Joseph A. De La Cerda, Boise, ID (US); Wenjun Wu, Shanghai (CN)

(21) Appl. No.: 19/270,118

(22) Filed: Jul. 15, 2025

Related U.S. Application Data
(60) Provisional application No. 63/675,709, filed on Jul. 25, 2024.

(51) Int. Cl. G06F 3/06

(52) U.S. Cl. CPC G06F 3/061; G06F 3/0659; G06F 3/0673

(57) ABSTRACT

Methods, systems, and devices for read operations for computational models are described. In some instances, a dedicated region (e.g., a region of logical block addresses (LBAs)) for storing a computational model may be established at a memory system. For instance, the dedicated region may be established across a range of LBAs. In response to a read command being received, the memory system (e.g., a memory system controller) may determine whether the LBA of the read command is associated with (e.g., included in) the range of LBAs for the dedicated region. If the read command's LBA is associated with the range of LBAs, the memory system may suspend one or more ongoing operations and read the data associated with the computational model (e.g., read the data stored to the dedicated region).

### CROSS REFERENCE

The present application for patent claims priority to U.S. Patent Application No. 63/675,709 by Bi et al., entitled “READ OPERATIONS FOR COMPUTATIONAL MODELS,” filed Jul. 25, 2024, which is assigned to the assignee hereof, and which is expressly incorporated by reference in its entirety herein.

### TECHNICAL FIELD

The following relates to one or more systems for memory, including read operations for computational models.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports read operations for computational models in accordance with examples as disclosed herein.

FIG. 2 shows an example of a system that supports read operations for computational models in accordance with examples as disclosed herein.

FIG. 3 shows an example of a process that supports read operations for computational models in accordance with examples as disclosed herein.

FIG. 4 shows a block diagram of a memory system that supports read operations for computational models in accordance with examples as disclosed herein.

FIG. 5 shows a flowchart illustrating a method or methods that support read operations for computational models in accordance with examples as disclosed herein.

### DETAILED DESCRIPTION

Some memory systems may store data associated with a computational model. For example, a memory system may store an artificial intelligence (AI) model, such as a large language model (LLM). Such models are often large in size and are accessed relatively frequently. Moreover, data may be read from such models in relatively large chunks (e.g., the size of each read operation may be relatively large). Conventional systems may interchangeably access the computational model and user data, which may affect the system's overall performance. That is, accessing relatively large portions of a computational model frequently, in conjunction with reading user data from and writing user data to the memory system, may result in relatively poor system performance. Accordingly, a memory system configured to access a computational model in a way that reduces its impact on the system's overall performance may be desirable.

A memory system configured to access a computational model in a way that reduces its impact on its overall performance is described herein. In some instances, a dedicated region (e.g., a region of logical block addresses (LBAs)) for storing a computational model may be established at a memory system. For instance, the dedicated region may be established across a range of LBAs. If a read command is received, the memory system (e.g., a memory system controller) may determine whether the LBA of the read command is associated with (e.g., included in) the range of LBAs for the dedicated region. If the read command's LBA is associated with the range of LBAs, the memory system may suspend one or more ongoing operations and read the data associated with the computational model (e.g., read the data stored to the dedicated region). For example, the memory system may suspend ongoing operations associated with reading user data from or writing user data to the memory system. By utilizing a dedicated region for the computational model and suspending ongoing operations if a read command associated with the dedicated region is received, the overall performance of the memory system may be improved.

In addition to applicability in memory systems as described herein, techniques for read operations for computational models may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving the read speed and efficiency, as well as the cache hit rate, during performing read operations on computational models, which may improve the system's overall performance and increase the amount of available volatile memory (e.g., SRAM), among other benefits.

Features of the disclosure are illustrated and described in the context of systems, devices, and circuits. Features of the disclosure are further illustrated and described in the context of block diagrams, processes, and flowcharts.

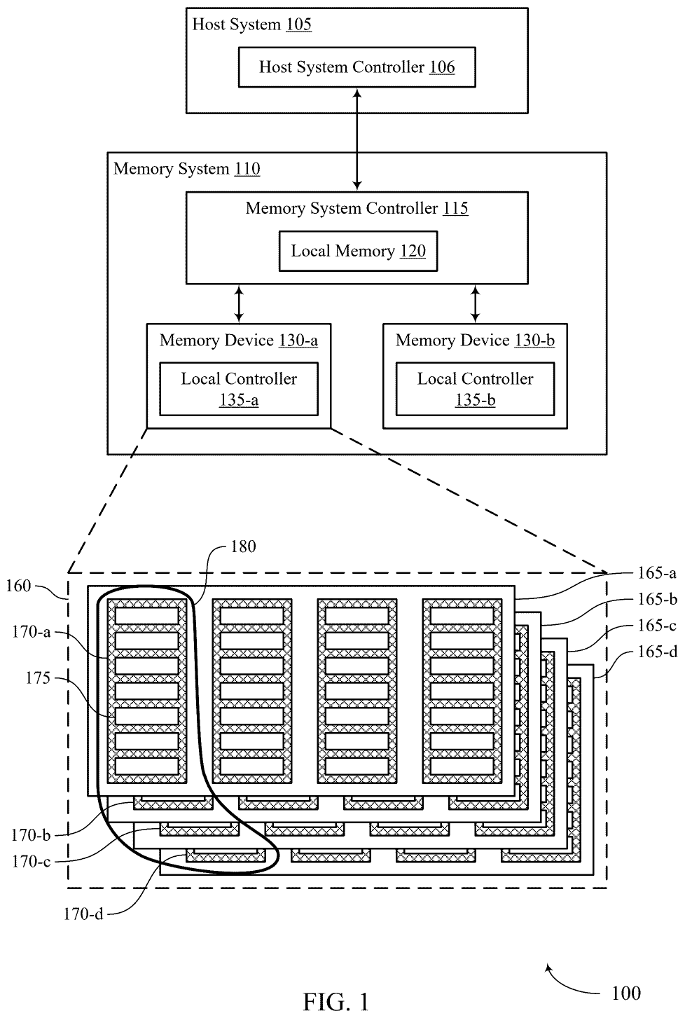

FIG. 1 shows an example of a system 100 that supports read operations for computational models in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

A memory system 110 configured to access a computational model in a way that reduces impact on its overall performance is described herein. In some instances, a dedicated region (e.g., a region of LBAs) for storing a computational model may be established at a memory system. For instance, the dedicated region may be established across a range of LBAs of the memory device 130. If a read command is received, the memory system 110 (e.g., a memory system controller 115) may determine whether the LBA of the read command is associated with (e.g., included in) the range of LBAs for the dedicated region of the memory device 130. If the read command's LBA is associated with the range of LBAs, the memory system 110 may suspend one or more ongoing operations and read the data associated with the computational model (e.g., read the data stored to the dedicated region of the memory device 130). For example, the memory system 110 may suspend ongoing operations associated with reading user data from or writing user data to the memory system (e.g., to the memory device 130). By utilizing a dedicated region for the computational model and suspending ongoing operations if a read command associated with the dedicated region is received, the overall performance of the memory system 110 may be improved.

The system 100 may include any quantity of non-transitory computer readable media that support read operations for computational models. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

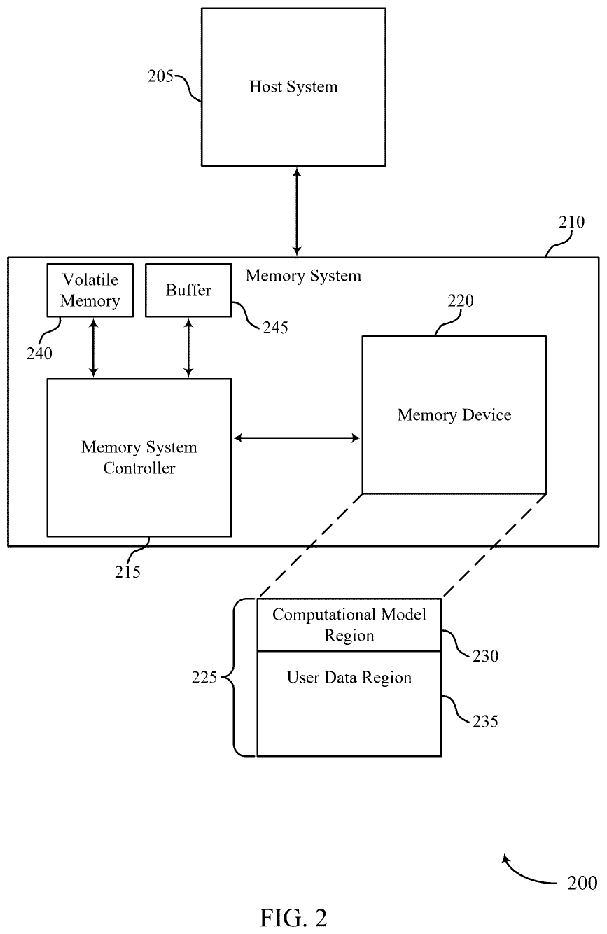

FIG. 2 shows an example of a block diagram of a system 200 that supports read operations for computational models in accordance with examples as disclosed herein. The block diagram may illustrate a system 200 that includes a host system 205 that is coupled with a memory system 210. In some examples, the host system 205 and the memory system 210 may be examples of the host system 105 and the memory system 110, respectively, as described with reference to FIG. 1. The memory system 210 may include a memory system controller 215 and a memory device 220. The memory device 220 may include or otherwise be associated with a range (e.g., a set) of LBAs 225. In some examples, the range of LBAs 225 may include a computational model region 230, and a user data region 235. By utilizing a dedicated region for the computational model (e.g., the computational model region 230), and suspending ongoing operations if a read command associated with the dedicated region is received, the overall performance of the memory system 210 may be improved.

The memory device 220 may include one or more memory arrays of non-volatile memory cells. For example, the memory device 220 may be or include one or more dies, and each die may include one or more planes. Each plane may include a respective set of blocks, where each block may include a respective set of pages, and each page may include a set of memory cells. Accordingly, the range of LBAs 225 may represent a range of LBAs 225 associated with the entire memory device 220, one or more dies, one or more planes, one or more blocks, or one or more pages. For illustrative purposes the range of LBAs 225 may be described as being associated with the entire memory device 220, but may instead be associated with a relatively smaller construct (e.g., a die instead of the memory device 220).

Each LBA of the range of LBAs 225 may correspond to a physical block address (PBA) of the memory device 220. In some examples, the memory device 220 may include a volatile memory 240 (e.g., SRAM) for storing a mapping between the LBAs of the range of LBAs 225 and corresponding PBAs. In some instances, the range of LBAs 225 may be sequential (e.g., contiguous) and the corresponding PBAs may be sequential or non-sequential. For example, LBA1 may correspond to PBA1, LBA2 may correspond to PBA2, and so on. However, in other examples, LBA1 may correspond to PBA10, LBA2 may correspond to PBA25, and so on.

In some instances, the computational model region 230 may be established to store data associated with a computational model, such as an LLM. The computational model region 230 may include or otherwise be associated with a set of sequential (e.g., contiguous) LBAs. In some instances, the set of sequential LBAs may correspond to one or more memory dies or blocks that include SLCs. For illustrative purposes, the computational model region 230 may be associated with LBA0-LBA100. In other examples, the user data region 235 may correspond to the remaining LBAs associated with the memory device 220 and may be used to store data other than data associated with the computational model. For example, the user data region 235 may store data that is read to and written by the host system 205. In some instances, the user data region 235 may be associated with LBAs corresponding to one or more memory dies or blocks that include SLCs, MLCs, TLCs, or QLCs. For illustrative purposes, the user data region 235 may be associated with LBA101-LBA200.

As used herein, a computational model may refer to any type of AI model. For example, a computational model may refer to a regression model, a random forest model, a LLM, a neural network, a machine learning model, a deep learning model, a supervised learning model, an unsupervised learning model, and the like. Additionally, or alternatively, the computational model may be read-only. That is, the computational model may be trained and established (and written to the memory device 220) such that it may only be read by the host system 205. In some instances, the computational model region 230 may be established and the computational model may be written (e.g., a single time) to the LBAs associated with the computational model region 230, and the computational model may be read-only thereafter.

To establish the computational model region 230, the host system 205 may transmit a command to the memory system 210 that includes one or more LBAs. The range of LBAs may correspond to the computational model region 230 and may be stored to the volatile memory 240. In some instances, the LBAs may be transmitted to the memory system 210 (e.g., from the host system 205) using a vendor unique (VU) command (sometimes referred to as a vendor specific command). A VU command may be defined by a standard, such as a UFS standard, and may be used to establish the computational model region 230. In other instances, the computational model region 230 may be established based on one or more attributes of the memory system 210. An attribute may be or may otherwise refer to a parameter of the memory system 210 that is used to monitor its status. In some instances, an attribute may be defined by a standard, such as a UFS standard, and may be used to establish the computational model region 230.

Once the computational model region 230 is established, the computational model may be stored to memory device 220. As described herein, the computational model may be read-only after being stored to the memory device 220 and may be stored to one or more PBAs associated with the LBAs of the computational model region 230. In some instances, the computational model may be stored to non-sequential PBAs that are included in one or more dies, planes blocks, or pages.

In some instances, if a read command is received by the memory system 210 (e.g., from the host system 205), the memory system controller 215 may determine whether a LBA associated with the read command is associated with (e.g., included in) the range of LBAs of the computational model region 230. For example, the computational model region 230 may be associated with LBA0-LBA100 and a read command may be associated with LBA25. In such instances, the read command may be for data associated with the computational model and the memory system controller 215 may suspend one or more ongoing operations to the user data region 235. In some examples, the memory system controller 215 may suspend all ongoing operations to the user data region 235, and may access the portion of the computational model associated with the read command.

If the memory system controller 215 suspends ongoing operations, the memory system 210 may be referred to as being in high performance mode (HPM). That is, while in HPM, the user data region 235 may not be accessed. Instead, only the computational model region 230 may be accessed, which may improve read timing and otherwise improve the overall performance of the memory system 210. After the memory system controller 215 has accessed the computational model region (e.g., after no more LBAs associated with the computational model region 230 are received), the memory system 210 may exit the HPM and access operations on the user data region 235 may resume.

Additionally, or alternatively, the memory system controller 215 may receive a read command and may determine that the associated LBA is not associated with (e.g., included in) the range of LBAs of the computational model region 230. Accordingly, the memory system controller 215 may access the associated data (e.g., the data stored to the user data region 235) without suspending any ongoing operations.

In other examples, the memory system controller 215 may receive a random read command for a relatively large quantity of data. For example, the random read command may be associated with data stored to multiple memory dies. In some instances, the memory system controller 215 may employ a “die balance” algorithm to delay the execution of the random read command on dies having a relatively high overhead and prioritize the execution of the random read command on dies having a relatively low overhead. That is, if a relatively large quantity of operations are being performed on a first memory die, the first memory die may be said to have a relatively high overhead. Thus, the portion of the random read command associated with the first memory die may be suspended (e.g., for a duration) until the first memory die has a relatively lower overhead (e.g., until a lesser quantity of operations are being performed).

Additionally or alternatively, if a relatively low quantity of operations are being performed on a second memory die, the second memory die may be said to have a relatively low overhead. Thus, the portion of the random read command associated with the second memory die may be performed (e.g., during the duration). Such operations may allow for relatively large random read commands to be performed on the computational model region 230 in a more efficient or effective manner.

In other examples, the memory system controller 215 may be configured to perform a prefetch operation based on one or more received LBAs. As used herein, a prefetch operation may refer to proactively loading data to the buffer 245 based on anticipating receiving data associated with a specific LBA. The buffer 245 may be or may be referred to as a SLC buffer 245. For example, the memory system may receive LBA4 followed by LBA5. In such examples, the memory system controller 215 may determine (e.g., anticipate) that LBA6 will be received, and may load the computational model data associated with LBA6 to the buffer 245. Accordingly, if LBA6 is received, the data may be transmitted to the host system 205 from the buffer 245 (e.g., instead of from the memory device 220).

In some instances, other types of data may be loaded to the buffer 245. For instance, an AI mode file (or another, similar type of file) may be pinned to the buffer 245. In some instances, the file may be pinned to the buffer 245 so that, if a read command for the associated data is received, the data may be read (e.g., transmitted to the host system 205) relatively quickly. In some instances, the data associated with the file may be loaded (e.g., to the buffer 245) from one or more MLCs or TLCs associated with the user data region 235.

In some examples, if an AI mode file or other type of file is loaded to the buffer 245, the buffer 245 may include relatively less free space. Accordingly, if buffer space is needed by another application or other operation (e.g., when the available space of the buffer 245 satisfies a first threshold value), the mode file may be transferred to the user data region 235 or another portion of the memory device 220. In some instances, if the data is transferred (e.g., from the SLC buffer 245), the data may be stored to one or more MLCs or TLCs.

Reading data from the buffer 245 may be referred to as a cache hit, and the likelihood of cache hits may be improved by establishing a computational model region 230 and prefetching data as described herein. Further, transmitting data to the host system 205 from the buffer may improve the speed at which data is read, and may otherwise improve the overall performance of the memory system 210. In some instances, the memory system controller 215 may prefetch data after any quantity of consecutive (e.g., contiguous) LBAs are received from the host system 205. By utilizing a dedicated region for the computational model (e.g., the computational model region 230), and suspending ongoing operations if a read command associated with the dedicated region is received, the overall performance of the memory system 210 may be improved.

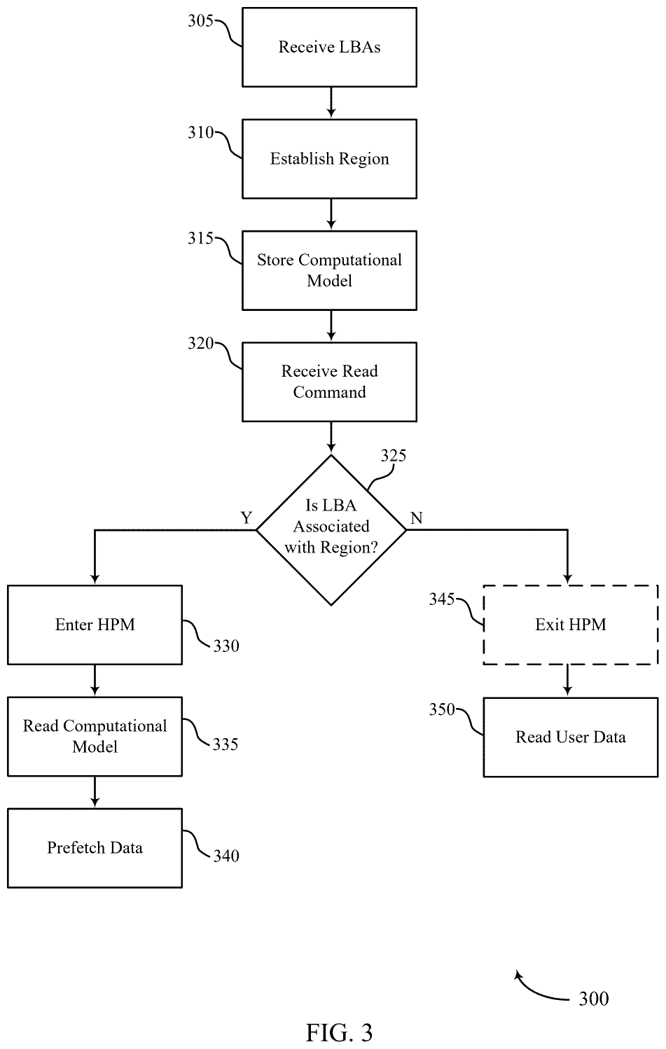

FIG. 3 shows an example of a process 300 that supports read operations for computational models in accordance with examples as disclosed herein. In some examples, the process 300 may be implemented by one or more aspects of systems 100 and 200. For instance, the process 300 may be implemented by a memory system 110 or 210 described with reference to FIGS. 1 and 2, respectively. In some examples, process 300 may correspond to one or more operations performed by the memory system to establish a region for storing a computational model. By utilizing a dedicated region for the computational model (e.g., the computational model region 230 as described with reference to FIG. 2), and suspending ongoing operations if a read command associated with the dedicated region is received, the overall performance of the associated memory system may be improved.

Aspects of the process 300 may be implemented by one or more controllers, among other components. Additionally, or alternatively, aspects of the process 300 may be implemented as instructions stored in one or more memories (e.g., firmware stored in one or more memories coupled with memory system 110 or 210). For example, the instructions, if executed by one or more controllers (e.g., the memory system controller 115 or 215), may cause the one or more controllers (or a device or a system) to perform the operations of the process 300.

At 305, one or more LBAs may be received. In some instances, the one or more LBAs may be transmitted from a host system to a memory system and may be received by a memory system controller. The one or more LBAs may include a range of contiguous LBAs that may be used for establishing a region (e.g., at the memory system) for storing a computational model, such as an LLM. In some instances, the one or more LBAs may be communicated to the memory device using a dedicated command, such as a VU command.

At 310, a region for storing a computational model may be established. In some instances, a memory system controller may establish the region after receiving the one or more LBAs (e.g., at 305). For instance, the memory system controller may store the one or more LBAs to a mapping (e.g., a mapping table, a L2P table) stored to a volatile memory of the memory system. The mapping may include the one or more LBAs and associated physical addresses (e.g., PBAs) of the memory system. As described herein, the LBAs may be contiguous and the PBAs may be or may not be contiguous. In other examples (not shown), the region may be established (e.g., at 310) based on one or more attributes of the memory system.

At 315, the computational model may be stored. In some instances, the memory system controller may receive the computational model (e.g., from a host system) and may store the computational model to PBAs associated with the LBAs. After storing (e.g., writing) the computational model to the PBAs, the computational model may no longer be written to (e.g., it may be read-only).

At 320, a read command may be received. In some examples, the memory system controller may receive the read command. The read command may be associated with one or more LBAs and may be for reading data associated with the computational model or user data.

At 325, it may be determined whether the one or more LBAs of the read command are included in the range of LBAs associated with the region for storing the computational model. In some instances, the memory system controller may compare the LBA (or LBAs) of the read command (e.g., received at 320) to the range of LBAs associated with the region for storing the computational model. If the received LBA is associated with (e.g., within the range), then the read command may be for the computational model and the process 300 may proceed to 330. In other instances, the received LBA may not be associated with (e.g., within the range), then the read command may be for user data and the process 300 may proceed to 345.

At 330, if the read command was determined to be for data associated with the computational model, a HPM may be entered. In some instances, the memory system controller may enter the memory system into a HPM in response to determining that the LBA (or LBAs) of the received read command are within the range of LBAs associated with the computational model. As described herein, entering a HPM may include suspending one, more than one, or all ongoing operations at the memory system. That is, operations associated with reading or writing user data may be suspended (e.g., temporarily suspended) until the computational model is accessed.

At 335, the computational model may be read. In some instances, the memory system controller may read the computational model (e.g., read the PBA(s) associated with the LBA(s) of the read command) after the memory system enters the HPM. The data may be communicated to a host system or other, external device (e.g., a device external to the memory system).

At 340, data may be prefetched. In some instances, the memory system controller may prefetch data by proactively loading (e.g., reading) data associated with the computational model to a buffer of the memory system. As described herein, data may be prefetched in response to receiving two or more consecutive LBAs in one or more read commands. That is, the memory system controller may anticipate that a subsequent, sequential LBA will be received and may proactively load the associated data to the buffer. Thus, if a read command for the data is received, a cache hit may occur and the data may be read directly from the buffer, which may save time and improve the memory system's performance. After optionally prefetching data, the process 300 may return to 320 (not shown). In other instances, if prefetching does not occur, the process 300 may return to 320 after 335 (e.g., after reading the computational model).

At 345, if the read command was determined not to be for data associated with the computational model, the memory system may exit an HPM. In some instances, the memory system may be in a HPM based on reading the computational model during a prior read operation. Accordingly, in such instances, the memory system controller may exit the memory system from the HPM. In other examples, the memory system may not be in a HPM and may proceed to 350.

At 350, user data may be read. In some instances, the memory system controller may read the user data if the received LBA is not associated with the LBAs of the region for storing the computational model. The data may be communicated to a host system or other, external device (e.g., a device external to the memory system). After reading the user data, the process 300 may return to 320 (not shown). By utilizing a dedicated region for the computational model (e.g., the computational model region 230 as described with reference to FIG. 2), and suspending ongoing operations if a read command associated with the dedicated region is received, the overall performance of the associated memory system may be improved.

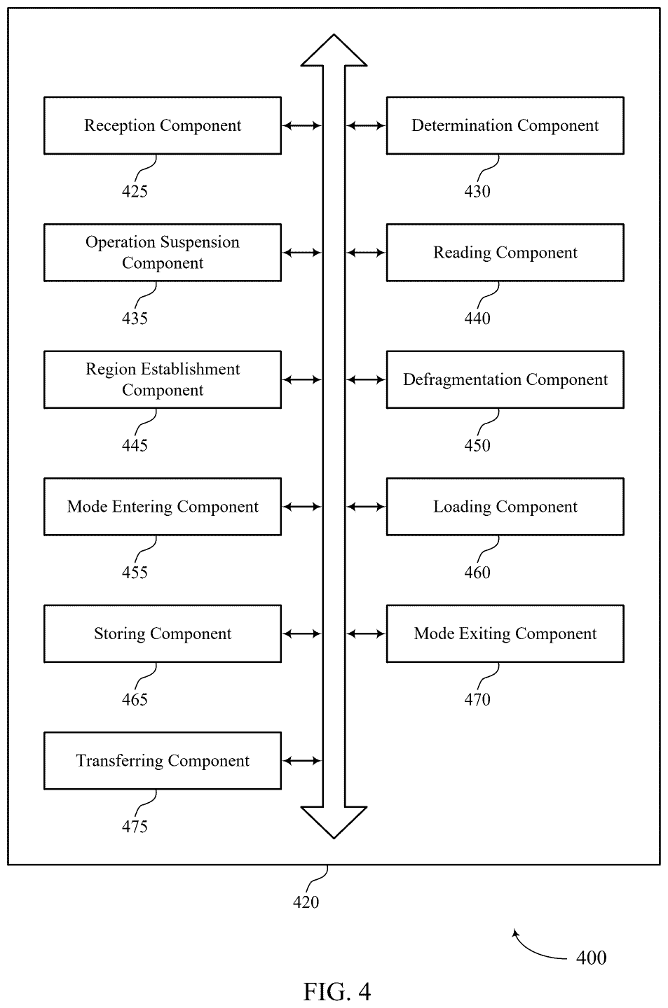

FIG. 4 shows a block diagram 400 of a memory system 420 that supports read operations for computational models in accordance with examples as disclosed herein. The memory system 420 may be an example of aspects of a memory system as described with reference to FIGS. 1 through 3. The memory system 420, or various components thereof, may be an example of means for performing various aspects of read operations for computational models as described herein. For example, the memory system 420 may include a reception component 425, a determination component 430, an operation suspension component 435, a reading component 440, a region establishment component 445, a defragmentation component 450, a mode entering component 455, a loading component 460, a storing component 465, a mode exiting component 470, a transferring component 475, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving a read command including a first logical block address of the memory system, where the memory system includes a region that stores a computational model. The determination component 430 may be configured as or otherwise support a means for determining whether the first logical block address is associated with the region in response to receiving the read command. The operation suspension component 435 may be configured as or otherwise support a means for suspending one or more operations being performed by the memory system in response to determining that the first logical block address is associated with the region. The reading component 440 may be configured as or otherwise support a means for reading data from a physical block address of the memory system in accordance with suspending the one or more operations and the first logical block address being associated with the region.

In some examples, the reception component 425 may be configured as or otherwise support a means for receiving a command to establish the region that stores the computational model. In some examples, the region establishment component 445 may be configured as or otherwise support a means for establishing the region for storing the computational model in response to receiving the command.

In some examples, the storing component 465 may be configured as or otherwise support a means for storing the computational model to the region after establishing the region.

In some examples, the region establishment component 445 may be configured as, or otherwise support, a means for establishing the region for storing computational model in accordance with one or more attributes of the memory system.

In some examples, the reception component 425 may be configured as or otherwise support a means for receiving a second read command including a second logical block address of the memory system. In some examples, the determination component 430 may be configured as or otherwise support a means for determining whether the second logical block address is associated with the region in response to receiving the second read command. In some examples, the reading component 440 may be configured as or otherwise support a means for reading, while the one or more operations are suspended, second data from a second physical block address of the memory system in accordance with the second logical block address being associated with the region.

In some examples, the loading component 460 may be configured as or otherwise support a means for loading, to a buffer of the memory system, third data from a third physical block address of the memory system as part of a prefetch operation and in accordance with the first logical block address and the second logical block address being sequential logical block addresses.

In some examples, the reception component 425 may be configured as or otherwise support a means for receiving a third read command including a third logical block address of the memory system. In some examples, the reading component 440 may be configured as or otherwise support a means for reading the third data from the buffer of the memory system in accordance with receiving the third read command and loading the third data to the buffer of the memory system.

In some examples, the determination component 430 may be configured as or otherwise support a means for determining, during a duration that the memory system is idle, whether physical block addresses corresponding the region include fragmented data. In some examples, the defragmentation component 450 may be configured as or otherwise support a means for defragmenting the fragmented data in response to determining that the physical block addresses corresponding to the region include fragmented data.

In some examples, to support determining whether the first logical block address is associated with the region, the determination component 430 may be configured as or otherwise support a means for determining whether the first logical block address is included in a logical-to-physical mapping stored to a volatile memory of the memory system.

In some examples, the logical-to-physical mapping is stored to the volatile memory of the memory system prior to receiving the read command.

In some examples, the mode entering component 455 may be configured as or otherwise support a means for entering, by the memory system, into a high performance mode in response to determining that the first logical block address is associated with the region, where suspending the one or more operations being performed by the memory system is in accordance with the memory system entering into the high performance mode.

In some examples, the mode exiting component 470 may be configured as or otherwise support a means for exiting, by the memory system, the high performance mode in response to reading the data from the physical block address of the memory system.

In some examples, the reception component 425 may be configured as or otherwise support a means for receiving a fourth read command including a fourth logical block address of the memory system. In some examples, the determination component 430 may be configured as or otherwise support a means for determining whether the fourth logical block address is associated with the region in response to receiving the fourth read command. In some examples, the loading component 460 may be configured as or otherwise support a means for loading one or more mappings between logical block addresses and physical block addresses of the memory system in response to determining that the fourth logical block address is not associated with the region. In some examples, the reading component 440 may be configured as or otherwise support a means for reading data from a fourth physical block address of the memory system in accordance with loading the one or more mappings between logical block addresses and physical block addresses of the memory system.

In some examples, the computational model includes an LLM.

In some examples, the region is associated with a range of logical block addresses.

In some examples, the physical block address includes one or more single level memory cells.

In some examples, the loading component 460 may be configured as or otherwise support a means for loading, to a buffer of the memory system, fourth data from a fourth physical block address of the memory system. In some examples, the reading component 440 may be configured as or otherwise support a means for reading the fourth data from the buffer of the memory system in accordance with receiving a fourth read command and loading the fourth data to the buffer of the memory system.

In some examples, the determination component 430 may be configured as or otherwise support a means for determining that a quantity of available storage of the buffer satisfies a first threshold value. In some examples, the transferring component 475 may be configured as or otherwise support a means for transferring the fourth data from the buffer of the memory system to a fifth physical block address, where the fifth physical block address includes one or more triple-level memory cells and is not associated with logical block addresses of the region.

In some examples, the reception component 425 may be configured as or otherwise support a means for receiving a random read command including a fifth logical block address of the memory system. In some examples, the determination component 430 may be configured as or otherwise support a means for determining that a size of data requested by the random read command satisfies a second threshold value and that the fifth logical block address is associated with the region in response to receiving the random read command. In some examples, the operation suspension component 435 may be configured as or otherwise support a means for suspending, for a duration, reading data from a first memory die in response to determining that the size of the data requested by the random read command satisfies the second threshold value and a first quantity of commands being performed at the first memory die satisfying a third threshold value. In some examples, the reading component 440 may be configured as or otherwise support a means for reading, during the duration, data from a second memory die in response to determining that the size of the data requested by the random read command satisfies the second threshold value and a second quantity of commands being performed at the second memory die failing to satisfy a fourth threshold value.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

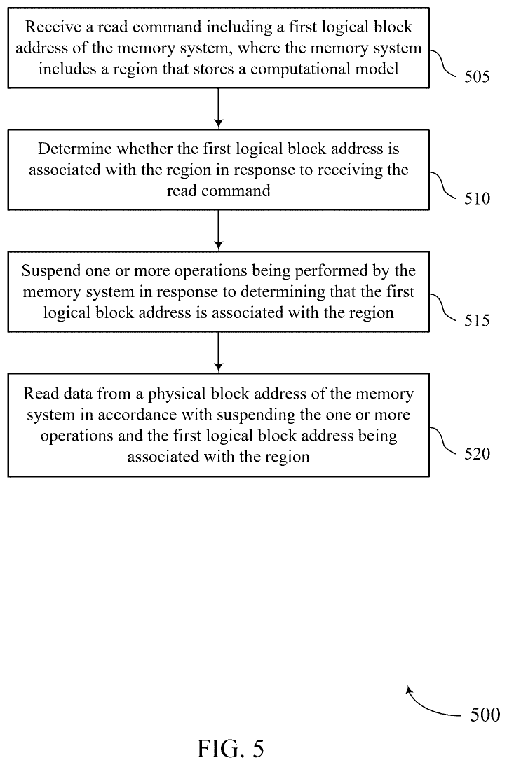

FIG. 5 shows a flowchart illustrating a method 500 that supports read operations for computational models in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a read command including a first logical block address of the memory system, where the memory system includes a region that stores a computational model. In some examples, aspects of the operations of 505 may be performed by a reception component 425 as described with reference to FIG. 4.

At 510, the method may include determining whether the first logical block address is associated with the region in response to receiving the read command. In some examples, aspects of the operations of 510 may be performed by a determination component 430 as described with reference to FIG. 4.

At 515, the method may include suspending one or more operations being performed by the memory system in response to determining that the first logical block address is associated with the region. In some examples, aspects of the operations of 515 may be performed by an operation suspension component 435 as described with reference to FIG. 4.

At 520, the method may include reading data from a physical block address of the memory system in accordance with suspending the one or more operations and the first logical block address being associated with the region. In some examples, aspects of the operations of 520 may be performed by a reading component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving a read command including a first logical block address of the memory system, where the memory system includes a region that stores a computational model; determining whether the first logical block address is associated with the region in response to receiving the read command; suspending one or more operations being performed by the memory system in response to determining that the first logical block address is associated with the region; and reading data from a physical block address of the memory system in accordance with suspending the one or more operations and the first logical block address being associated with the region.
Aspect 2: The method, apparatus, or non-transitory computer-readable medium of aspect 1, further including operations, features, circuitry, logic, means, or instructions, or any combination thereof for receiving a command to establish the region that stores the computational model and establishing the region for storing the computational model in response to receiving the command.
Aspect 3: The method, apparatus, or non-transitory computer-readable medium of aspect 2, further including operations, features, circuitry, logic, means, or instructions, or any combination thereof for storing the computational model to the region after establishing the region.
Aspect 4: The method, apparatus, or non-transitory computer-readable medium of any of aspects 1 through 3, further including operations, features, circuitry, logic, means, or instructions, or any combination thereof for establishing the region for storing computational model in accordance with one or more attributes of the memory system.
Aspect 5: The method, apparatus, or non-transitory computer-readable medium of any of aspects 1 through 4, further including operations, features, circuitry, logic, means, or instructions, or any combination thereof for receiving a second read command including a second logical block address of the memory system; determining whether the second logical block address is associated with the region in response to receiving the second read command; and reading, while the one or more operations are suspended, second data from a second physical block address of the memory system in accordance with the second logical block address being associated with the region.
Aspect 6: The method, apparatus, or non-transitory computer-readable medium of aspect 5, further including operations, features, circuitry, logic, means, or instructions, or any combination thereof for loading, to a buffer of the memory system, third data from a third physical block address of the memory system as part of a prefetch operation and in accordance with the first logical block address and the second logical block address being sequential logical block addresses.
Aspect 7: The method, apparatus, or non-transitory computer-readable medium of aspect 6, further including operations, features, circuitry, logic, means, or instructions, or any combination thereof for receiving a third read command including a third logical block address of the memory system and reading the third data from the buffer of the memory system in accordance with receiving the third read command and loading the third data to the buffer of the memory system.
Aspect 8: The method, apparatus, or non-transitory computer-readable medium of any of aspects 1 through 7, further including operations, features, circuitry, logic, means, or instructions, or any combination thereof for determining, during a duration that the memory system is idle, whether physical block addresses corresponding the region include fragmented data and defragmenting the fragmented data in response to determining that the physical block addresses corresponding to the region include fragmented data.
Aspect 9: The method, apparatus, or non-transitory computer-readable medium of any of aspects 1 through 8, where determining whether the first logical block address is associated with the region includes operations, features, circuitry, logic, means, or instructions, or any combination thereof for determining whether the first logical block address is included in a logical-to-physical mapping stored to a volatile memory of the memory system.
Aspect 10: The method, apparatus, or non-transitory computer-readable medium of aspect 9, where the logical-to-physical mapping is stored to the volatile memory of the memory system prior to receiving the read command.
Aspect 11: The method, apparatus, or non-transitory computer-readable medium of any of aspects 1 through 10, further including operations, features, circuitry, logic, means, or instructions, or any combination thereof for entering, by the memory system, into a high performance mode in response to determining that the first logical block address is associated with the region, where suspending the one or more operations being performed by the memory system is in accordance with the memory system entering into the high performance mode.
Aspect 12: The method, apparatus, or non-transitory computer-readable medium of aspect 11, further including operations, features, circuitry, logic, means, or instructions, or any combination thereof for exiting, by the memory system, the high performance mode in response to reading the data from the physical block address of the memory system.
Aspect 13: The method, apparatus, or non-transitory computer-readable medium of any of aspects 1 through 12, further including operations, features, circuitry, logic, means, or instructions, or any combination thereof for receiving a fourth read command including a fourth logical block address of the memory system; determining whether the fourth logical block address is associated with the region in response to receiving the fourth read command; loading one or more mappings between logical block addresses and physical block addresses of the memory system in response to determining that the fourth logical block address is not associated with the region; and reading data from a fourth physical block address of the memory system in accordance with loading the one or more mappings between logical block addresses and physical block addresses of the memory system.
Aspect 14: The method, apparatus, or non-transitory computer-readable medium of any of aspects 1 through 13, where the computational model includes an LLM.
Aspect 15: The method, apparatus, or non-transitory computer-readable medium of any of aspects 1 through 14, where the region is associated with a range of logical block addresses.
Aspect 16: The method, apparatus, or non-transitory computer-readable medium of any of aspects 1 through 15, where the physical block address includes one or more single level memory cells.
Aspect 17: The method, apparatus, or non-transitory computer-readable medium of any of aspects 1 through 16, further including operations, features, circuitry, logic, means, or instructions, or any combination thereof for loading, to a buffer of the memory system, fourth data from a fourth physical block address of the memory system and reading the fourth data from the buffer of the memory system in accordance with receiving a fourth read command and loading the fourth data to the buffer of the memory system.
Aspect 18: The method, apparatus, or non-transitory computer-readable medium of aspect 17, further including operations, features, circuitry, logic, means, or instructions, or any combination thereof for determining that a quantity of available storage of the buffer satisfies a first threshold value and transferring the fourth data from the buffer of the memory system to a fifth physical block address, where the fifth physical block address includes one or more triple-level memory cells and is not associated with logical block addresses of the region.
Aspect 19: The method, apparatus, or non-transitory computer-readable medium of any of aspects 1 through 18, further including operations, features, circuitry, logic, means, or instructions, or any combination thereof for receiving a random read command including a fifth logical block address of the memory system; determining that a size of data requested by the random read command satisfies a second threshold value and that the fifth logical block address is associated with the region in response to receiving the random read command; suspending, for a duration, reading data from a first memory die in response to determining that the size of the data requested by the random read command satisfies the second threshold value and a first quantity of commands being performed at the first memory die satisfying a third threshold value; and reading, during the duration, data from a second memory die in response to determining that the size of the data requested by the random read command satisfies the second threshold value and a second quantity of commands being performed at the second memory die failing to satisfy a fourth threshold value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, and/or materials. In some examples, one layer or level may be composed of two or more sublayers or sublevels.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a read command comprising a first logical block address of the memory system, wherein the memory system comprises a region that stores a computational model;
determine whether the first logical block address is associated with the region in response to receiving the read command;
suspend one or more operations being performed by the memory system in response to determining that the first logical block address is associated with the region; and
read data from a physical block address of the memory system in accordance with suspending the one or more operations and the first logical block address being associated with the region.

2. The memory system of claim 1, wherein the processing circuitry is further configured to cause the memory system to:
receive a command to establish the region that stores the computational model; and
establish the region for storing the computational model in response to receiving the command.

3. The memory system of claim 2, wherein the processing circuitry is further configured to cause the memory system to:
store the computational model to the region after establishing the region.

4. The memory system of claim 1, wherein the processing circuitry is further configured to cause the memory system to:
establish the region for storing computational model in accordance with one or more attributes of the memory system.

5. The memory system of claim 1, wherein the processing circuitry is further configured to cause the memory system to:
receive a second read command comprising a second logical block address of the memory system;
determine whether the second logical block address is associated with the region in response to receiving the second read command; and
read, while the one or more operations are suspended, second data from a second physical block address of the memory system in accordance with the second logical block address being associated with the region.

6. The memory system of claim 5, wherein the processing circuitry is further configured to cause the memory system to:
loading, to a buffer of the memory system, third data from a third physical block address of the memory system as part of a prefetch operation and in accordance with the first logical block address and the second logical block address be sequential logical block addresses.

7. The memory system of claim 6, wherein the processing circuitry is further configured to cause the memory system to:
receive a third read command comprising a third logical block address of the memory system; and
read the third data from the buffer of the memory system in accordance with receiving the third read command and loading the third data to the buffer of the memory system.

8. The memory system of claim 1, wherein the processing circuitry is further configured to cause the memory system to:
determine, during a duration that the memory system is idle, whether physical block addresses corresponding the region comprise fragmented data; and
defragment the fragmented data in response to determining that the physical block addresses corresponding to the region comprise fragmented data.

9. The memory system of claim 1, wherein determining whether the first logical block address is associated with the region comprises the processing circuitry configured to cause the memory system to:
determine whether the first logical block address is included in a logical-to-physical mapping stored to a volatile memory of the memory system.

10. The memory system of claim 9, wherein the logical-to-physical mapping is stored to the volatile memory of the memory system prior to receiving the read command.

11. The memory system of claim 1, wherein the processing circuitry is further configured to cause the memory system to:
enter, by the memory system, into a high performance mode in response to determining that the first logical block address is associated with the region, wherein suspending the one or more operations being performed by the memory system is in accordance with the memory system entering into the high performance mode.

12. The memory system of claim 11, wherein the processing circuitry is further configured to cause the memory system to:
exiting, by the memory system, the high performance mode in response to read the data from the physical block address of the memory system.

13. The memory system of claim 1, wherein the processing circuitry is further configured to cause the memory system to:
receive a fourth read command comprising a fourth logical block address of the memory system;
determine whether the fourth logical block address is associated with the region in response to receiving the fourth read command;
load one or more mappings between logical block addresses and physical block addresses of the memory system in response to determining that the fourth logical block address is not associated with the region; and
read data from a fourth physical block address of the memory system in accordance with loading the one or more mappings between logical block addresses and physical block addresses of the memory system.

14. The memory system of claim 1, wherein the computational model comprises a large language model (LLM).

15. The memory system of claim 1, wherein the region is associated with a range of logical block addresses.

16. The memory system of claim 1, wherein the physical block address comprises one or more single level memory cells.

17. The memory system of claim 1, wherein the processing circuitry is further configured to cause the memory system to:
load, to a buffer of the memory system, fourth data from a fourth physical block address of the memory system; and
read the fourth data from the buffer of the memory system in accordance with receiving a fourth read command and loading the fourth data to the buffer of the memory system.

18. The memory system of claim 17, wherein the processing circuitry is further configured to cause the memory system to:
determine that a quantity of available storage of the buffer satisfies a first threshold value; and
transfer the fourth data from the buffer of the memory system to a fifth physical block address, wherein the fifth physical block address comprises one or more triple-level memory cells and is not associated with logical block addresses of the region.

19. The memory system of claim 1, wherein the processing circuitry is further configured to cause the memory system to:
receive a random read command comprising a fifth logical block address of the memory system;
determine that a size of data requested by the random read command satisfies a second threshold value and that the fifth logical block address is associated with the region in response to receiving the random read command;
suspend, for a duration, reading data from a first memory die in response to determining that the size of the data requested by the random read command satisfies the second threshold value and a first quantity of commands being performed at the first memory die satisfying a third threshold value; and
read, during the duration, data from a second memory die in response to determining that the size of the data requested by the random read command satisfies the second threshold value and a second quantity of commands being performed at the second memory die failing to satisfy a fourth threshold value.

20. A non-transitory computer-readable medium storing code comprising instructions which, when executed by one or more processors of a memory system, cause the memory system to:
receive a read command comprising a first logical block address of the memory system, wherein the memory system comprises a region that stores a computational model;
determine whether the first logical block address is associated with the region in response to receiving the read command;
suspend one or more operations being performed by the memory system in response to determining that the first logical block address is associated with the region; and
read data from a physical block address of the memory system in accordance with suspending the one or more operations and the first logical block address being associated with the region.

21. The non-transitory computer-readable medium of claim 20, wherein the instructions, when executed by the one or more processors of the memory system, further cause the memory system to:
receive a command to establish the region that stores the computational model; and
establish the region for storing the computational model in response to receiving the command.

22. The non-transitory computer-readable medium of claim 21, wherein the instructions, when executed by the one or more processors of the memory system, further cause the memory system to:
store the computational model to the region after establishing the region.

23. The non-transitory computer-readable medium of claim 20, wherein the instructions, when executed by the one or more processors of the memory system, further cause the memory system to:
establish the region for storing computational model in accordance with one or more attributes of the memory system.

24. The non-transitory computer-readable medium of claim 20, wherein the instructions, when executed by the one or more processors of the memory system, further cause the memory system to:
receive a second read command comprising a second logical block address of the memory system;
determine whether the second logical block address is associated with the region in response to receiving the second read command; and
read, while the one or more operations are suspended, second data from a second physical block address of the memory system in accordance with the second logical block address being associated with the region.

25. A method by a memory system, comprising:
receiving a read command comprising a first logical block address of the memory system, wherein the memory system comprises a region that stores a computational model;
determining whether the first logical block address is associated with the region in response to receiving the read command;
suspending one or more operations being performed by the memory system in response to determining that the first logical block address is associated with the region; and
reading data from a physical block address of the memory system in accordance with suspending the one or more operations and the first logical block address being associated with the region.
